(19) United States
(12) Patent Application Publication
(10) Pub. No.: US 2002/0026404 A1
(43) Pub. Date: Feb. 28, 2002

(54) Apparatus and method for displaying trading trends

(76) Inventor: George W. Thompson, Carrollton, TX (US)

Correspondence Address: Daniel J. Chalker, Gardere Wynne Sewell LLP, 3000 Thanksgiving Tower, 1601 Elm Street, Suite 3000, Dallas, TX, 75201-4767, US

(21) Appl. No.: 09/888,040

(22) Filed: Jun. 23, 2001

Related U.S. Application Data
(60) Provisional application No. 60/213,576, filed on Jun. 22, 2000.

(51) Int. Cl. G06F 17/60

(52) U.S. Cl. 705/37; 705/36

(57) ABSTRACT

The present invention provides an apparatus and method of displaying trading trends for an investment wherein an opening value and a closing value for the investment for two or more time intervals is received. An opening value trend using a market trend indicator and the opening values for the investment is calculated, and a closing value trend using the market trend indicator and the closing values for the investment is calculated. A visual indicator comparing the opening value trend to the closing value trend for the investment is then displayed. This method may be incorporated into a computer program embodied in a computer readable medium using code segments to accomplish the method described above.

### RELATED APPLICATIONS

This application claims priority to U.S. Provisional Patent Application Ser. No. 60/213,576 filed on Jun. 22, 2000, the disclosure of which is herein incorporated by reference.

### FIELD OF THE INVENTION

The present invention relates in general to the field of investment software and more particularly to an apparatus and method for providing a visual display of a two line cross-over method signaling buying and selling opportunities of stocks, bonds, and commodities.

### BACKGROUND OF THE INVENTION

With the advent of electronic trading, it is more critical than ever to make appropriate entry and exit decisions quickly to maximize profits while minimizing losses. This is especially true with day trading. The investor can also be easily overwhelmed by the vast amount of information available about a specific market, industry sector or investment. In addition, when investors trade the live market without any trend indication relative to the stock being traded, they are not trading with the trend. The stock price, therefore, will move further against the investor's entry point and thousands of dollars can be lost while the investor waits for the movement to come back their way. If the investor is long in the stock, but the trend is short, the stock movement may never return the investor's way.

There is, therefore, a need for an apparatus and method to analyze market data and develop trade information, which reduces the risk and loss for the investor. There is also a need for an apparatus and method to provide the investor with greater order entry/exit guidance than might be received through a broker or through monitoring the raw market data.

### SUMMARY OF THE INVENTION

The present invention relates to investment software and provides an apparatus and method for displaying trading trends. Such an apparatus and method can be used, for example, to display signals for buying and selling opportunities of stocks, bonds and commodities. The present invention can be used by anyone interested in investments, such as individual investors, investment brokers and mutual fund managers. As a result, the present invention provides an apparatus and method for minimizing risk when trading in the market, displaying investment movement and trends, and identifying investments that have a specific trend.

The present invention can be used to analyze market data and develop trade information, which reduces the risk and loss for the investor. Thus, traders of stocks, bonds and commodities can manage their investment portfolios from their home, office or location of their choice. By providing them with greater order entry/exit guidance than might be received through a broker or through monitoring the raw market data, the present invention enables the trader to make better trade decisions because it easier to track the performance of the stocks, bond or commodities being monitored.

In addition, the present invention extrapolates trade trends in a selected investment and provides the investor with current price information, trade trends, trade indicators, long and short positions and active trade information. The investor can watch for an intersection cross of the trade trends and, guided by colors, take the appropriate action. For example, the color green may indicate that the price of the selected investment is going up and signal the investor that it is time to buy. Conversely, the color red may indicate that the price going down and signal the investor that it is time to sell or go short. Other colors can be used. The present invention also shows the number of shares, the price, and the last active price per share. Trade indicators with adjustable time intervals are also color-coded. These time intervals allow the investor to monitor the time to best apply the trade.

The present invention allows the investor to access market information or trade data via Internet Web sites, dial-up and other network connections and define specific search parameters, which effectively “weed-out” unqualified or undesirable trade opportunities. The investor can identify and restrict investment price ranges above and below certain price points, and indicate the desired volume minimum and spread maximum. The present invention will not identify any trade opportunity that does not meet the parameters input by the investor. Locating and identifying these trend friendly trades reduces risk. The present invention will also alert the investor when an exit of an investment should occur. These alerts can be a combination of audio and visual notifications.

The present invention also allows the investor to practice trades in a live market environment without risking capital. The present invention obtains trade data form the selected market(s) and continuously updates the information provided to the investor each time an investment purchase or sell transaction occurs. Using this information, the present invention provides the entry, exit and trend data to the investor.

The present invention provides an apparatus for displaying trading trends for an investment having a computer and a display. The computer is communicably connected to a market information source, and the display is communicably connected to the computer. The computer receives an opening value and a closing value for the investment for two or more time intervals from the market information source, calculates an opening value trend using a market trend indicator and the opening values for the investment, calculates a closing value trend using the market trend indicator and the closing values for the investment, and displays a visual indicator comparing the opening value trend to the closing value trend for the investment on the display.

In addition, the present invention provides a method of displaying trading trends for an investment wherein an opening value and a closing value for the investment for two or more time intervals is received. An opening value trend using a market trend indicator and the opening values for the investment is calculated, and a closing value trend using the market trend indicator and the closing values for the investment is calculated. A visual indicator comparing the opening value trend to the closing value trend for the investment is then displayed. This method may be incorporated into a computer program embodied in a computer readable medium using code segments to accomplish the method described above.

Other features and advantages of the present invention will be apparent to those of ordinary skill in the art upon reference to the following detailed description taken in conjunction with the accompanying drawings.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts in which:

FIG. 1 is a block diagram illustrating the possible interaction between data systems in accordance with one embodiment of the present invention;

FIG. 2 is a flowchart illustrating the data update process in accordance with one embodiment of the present invention;

FIG. 3 is the Overview Screen in Overview Mode in accordance with one embodiment of the present invention;

FIG. 4 is the Overview Screen in Trading Mode in accordance with one embodiment of the present invention;

FIG. 5 is the Chart Screen in accordance with one embodiment of the present invention;

FIG. 6 is the Search Screen in accordance with one embodiment of the present invention;

FIG. 7 is the Gainers/Losers Screen in accordance with one embodiment of the present invention;

FIG. 8A is a flowchart illustrating the application start-up and processing flow for the Overview Screen in Overview Mode in accordance with one embodiment of the present invention;

FIG. 8B is a flowchart illustrating the processing flow for the Overview Screen in Trading Mode in accordance with one embodiment of the present invention;

FIG. 8C is a flowchart illustrating the processing flow for the Chart Screen in accordance with one embodiment of the present invention;

FIG. 8D is a flowchart illustrating the processing flow for the Search Screen in accordance with one embodiment of the present invention;

FIG. 8E is a flowchart illustrating the processing flow for the Gainers/Losers Screen in accordance with one embodiment of the present invention;

FIG. 9 is the Trading Screen in accordance with another embodiment of the present invention;

FIG. 10 is the Trade Vault Screen in accordance with another embodiment of the present invention;

FIG. 11 is the Overview Screen in accordance with another embodiment of the present invention;

FIG. 12 is the Parameters Screen in accordance with another embodiment of the present invention; and

FIG. 13 is the Gainers/Losers Screen in accordance with another embodiment of the present invention.

### DETAILED DESCRIPTION OF THE INVENTION

It should be understood that the principles and applications disclosed herein can be applied to a wide range of trading scenarios, such as stocks, bonds and commodities. For purposes of explanation and illustration, the present invention is hereafter described in reference to the management of investment portfolios. The present invention relates to investment software that provides an apparatus and method for displaying trading trends. Such an apparatus and method can be used, for example, to display signals for buying and selling opportunities of stocks, bonds and commodities. The present invention can be used by anyone interested in investments, such as individual investors, investment brokers and mutual fund managers. As a result, the present invention provides an apparatus and method for minimizing risk when trading in the market, displaying investment movement and trends, and identifying investments that have a specific trend.

The present invention can be used to analyze market data and develop trade information, which reduces the risk and loss for the investor. Thus, traders of stocks, bonds and commodities can manage their investment portfolios from their home, office or location of their choice. By providing them with greater order entry/exit guidance than might be received through a broker or through monitoring the raw market data, the present invention enables the trader to make better trade decisions because it easier to track the performance of the stocks, bond or commodities being monitored.

In addition, the present invention extrapolates trade trends in a selected investment and provides the investor with current price information, trade trends, trade indicators, long and short positions and active trade information. The investor can watch for an intersection cross of the trade trends and, guided by colors, take the appropriate action. For example, the color green may indicate that the price of the selected investment is going up and signal the investor that it is time to buy. Conversely, the color red may indicate that the price going down and signal the investor that it is time to sell or go short. Other colors can be used. The present invention also shows the number of shares, the price, and the last active price per share. Trade indicators with adjustable time intervals are also color-coded. These time intervals allow the investor to monitor the time to best apply the trade.

The present invention allows the investor to access market information or trade data via Internet Web sites, dial-up and other network connections and define specific search parameters, which effectively “weed-out” unqualified or undesirable trade opportunities. The investor can identify and restrict investment price ranges above and below certain price points, and indicate the desired volume minimum and spread maximum. The present invention will not identify any trade opportunity that does not meet the parameters input by the investor. Locating and identifying these trend friendly trades reduces risk. The present invention will also alert the investor when an exit of an investment should occur. These alerts can be a combination of audio and visual notifications.

The present invention also allows the investor to practice trades in a live market environment without risking capital. The present invention obtains trade data form the selected market(s) and continuously updates the information provided to the investor each time an investment purchase or sell transaction occurs. Using this information, the present invention provides the entry, exit and trend data to the investor.

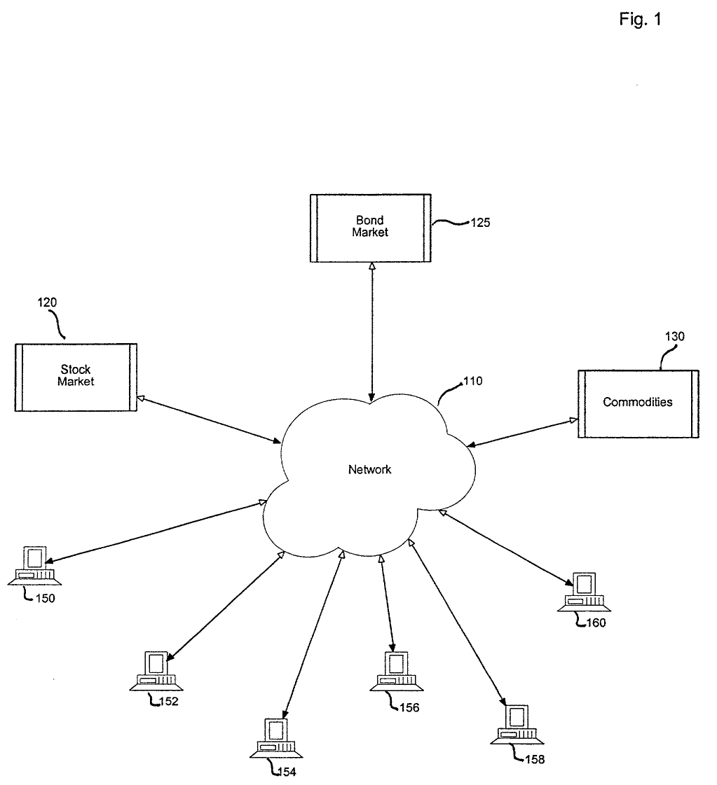

Now referring to FIG. 1, a block diagram illustrating the possible interaction between data systems in accordance with one embodiment of the present invention is shown. Investors 150, 152, 154, 156, 158 and 160 interact with the various investment markets (Stocks) 120, (Bonds) 125 and (Commodities) 130 via network 110, which may comprise any typical communications network such as telephone, Internet, satellite or any combination thereof. Access to the market information sources or markets 120, 125 and 130 can be achieved through a service specific to each market, or through a third-party server that will allow access to one or more of the markets 120, 125 or 130. Investors 150, 152, 154, 156, 158 and 160 can access the network 110 using a personal computer, workstation or laptop computer. The present invention can be implemented as an application on each investor's computer 150-160, or as a server-based application accessible by investors 150-160 via a network or other communications link. The number of investors 150, 152, 154, 156, 158 and 160 shown in FIG. 1 is simply representative and does not indicate a limitation on the number of investors that may use the present invention at a given time. Nor is the number of investment types or markets 120, 125 and 130 intended to limit the number or types of investments that may analyzed with the present invention.

In one method of accessing the present invention, a personal computer 150-160 equipped with a modem can be used to obtain this data from the market information source or market 120, 125 and 130 via the network 110 at a fee for the exchange in a manner well known in the art. A subscription to a real-time or near-real-time investment reporting system is needed. An example of such a system is PCQuote, which interfaces with the Taltrade ActiveX components. The Taltrade components execute Taltrade Query Language (TQL) commands. These commands retrieve investment information from the markets in real-time. The present invention can use data from multiple sources. The minimum system requirements for a personal computer would be Windows 95/NT, 64 MB RAM, CD-ROM, 25 MB available hard drive space, an Internet connection and Level I or Level II data feed. The ideal system requirements for a personal computer would be Windows 98, 128 MB RAM, CD-ROM, 25 MB available hard drive space and a high speed Internet connection such as: ISDN, DSL, T1, T3 or cable; or better.

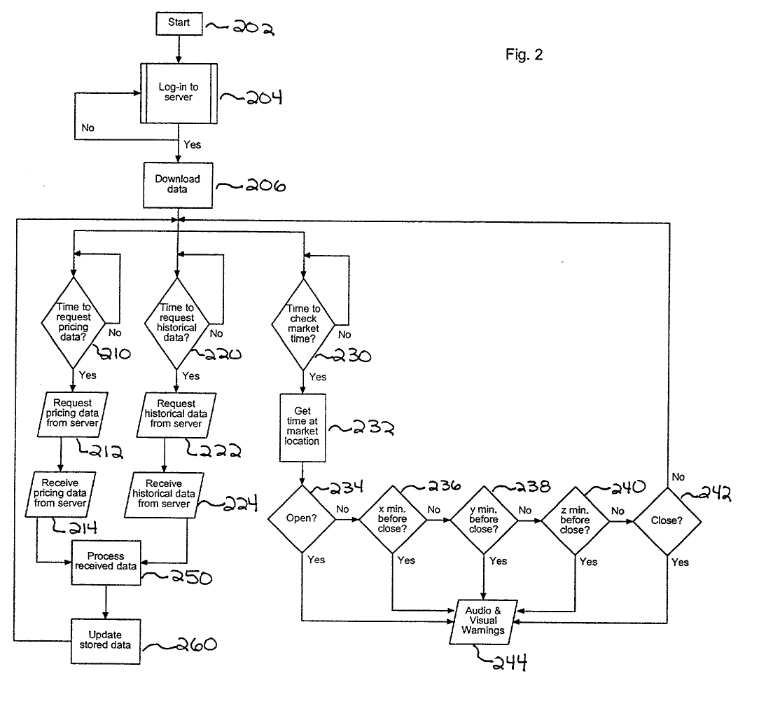

Referring now to FIG. 2, a flowchart illustrating the data update process in accordance with one embodiment of the present invention is shown. The present invention starts in block 202 where the investor 150-160 (FIG. 1) selects one or more markets 120, 125 or 130 (FIG. 1) to connect to. The specific servers that may be connected to and the details regarding the connection to be established are typically setup during the installation process of the software. The investor 150-160 (FIG. 1) can change, add or delete available connections and/or markets. Next, the present invention prompts the investor to log-on to a server, which preferably supplies investment information updates in real-time or near-realtime 204. At this point, the present invention downloads investment information in block 206. The download can be performed in a variety of ways. For example, the data may be requested on a regularly scheduled basis, such as every 10 seconds, or in response to the occurrence of some selected event, such as a mouse click. Alternatively, the data may be sent from the market 120, 125, 130 (FIG. 1) or other data source to the investor 150-160 (FIG. 1) on a regularly scheduled basis or in response to the occurrence of some selected event, such as a change in the data. In one embodiment, the data is acquired by executing TQL (Taltrade Query Language) commands through the Taltrade ActiveX components. These commands are executed on a regular basis by two application timer controls 210 and 220, which send TQL requests to the server at regular intervals via Taltrade controls 212 and 222. Taltrade controls 214 and 224 receive the results from the TQL queries. The results are preferably returned from Taltrade servers in an asynchronous manner. That is, the requests do not have to wait on the returned data. Window events are fired when the results are returned. The present invention then processes the received data 250, which is used to update the stored pricing and volume data 260. Historical data that is retrieved from the Taltrade server is also used to update the stored data 260.

It is beneficial for the investor to be aware of the time at the market location because trading cannot occur prior to the opening of a given market nor after its close. Therefore, a way to notify the investor of the given market's opening and to warn the investor of the given market's impending close also improves the investor's ability to make trade decision. In a preferred embodiment shown in FIG. 2, application timer 230 monitors the time at the market location 232 in order to notify the investor of the opening of the market Setpoint 234 and at several intervals approaching the close of the market Setpoints 236, 238, 240 and 242. If the time at the market location 232 equals the time in any of Setpoints 234, 236, 238, 240 and 242, the investor is notified 244. For example, the opening of the market Setpoint 234 could be 10 a.m., while the intervals approaching the close of the market Setpoints 236, 238, 240 and 242 could be 3:30 p.m., 3:45 p.m., 3:55 p.m. and close at 4 p.m., respectively.

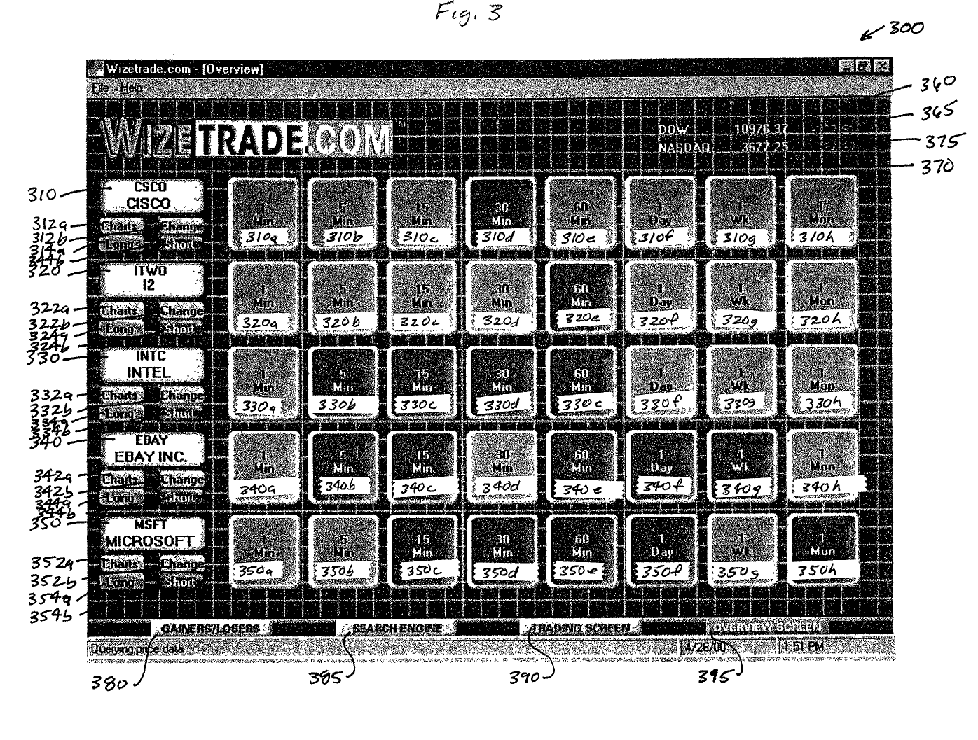

FIG. 3 is the Overview Screen 300 in Overview Mode in accordance with one embodiment of the present invention. The Overview Screen 300 enables the investor to recognize trends and directional movements. This screen is visible most of the time. Overview Screen 300 contains information about several selected investments 310, 320, 330, 340 and 350. In this example, investment 310 is Cisco, 320 is 12, 330 is Intel, 340 is Ebay and 350 is Microsoft. Color coded indicators 310a-310h, 320a-320h, 330a-330h, 340a-340h and 350a-350h are displayed for each of the selected investments 310, 320, 330, 340 and 350. These indicators are preferably laid out in a grid fashion, but can be otherwise configured. Each indicator 310a-310h, 320a-320h, 330a-330h, 340a-340h and 350a-350h represents information for an associated single investment. Each indicator 310a-310h, 320a-320h, 330a-330h, 340a-340h and 350a-350h displays the chosen time interval for that indicator. Time intervals may be in minutes, hours, days, weeks or months. In the example shown, the time interval for indicators 310a, 320a, 330a, 340a and 350a is one minute; the time interval for indicators 310b, 320b, 330b, 340b and 350b is five minutes; the time interval for indicators 310c, 320c, 330c, 340c and 350c is fifteen minutes; the time interval for indicators 310d, 320d, 330d, 340d and 350d is thirty minutes; the time interval for indicators 310e, 320e, 330e, 340e and 350e is sixty minutes; the time interval for indicators 310f, 320f, 330f, 340f and 350f is one day; the time interval for indicators 310g, 320g, 330g, 340g and 350g is one week; and the time interval for indicators 310h, 320h, 330h, 340h and 350h is one month.

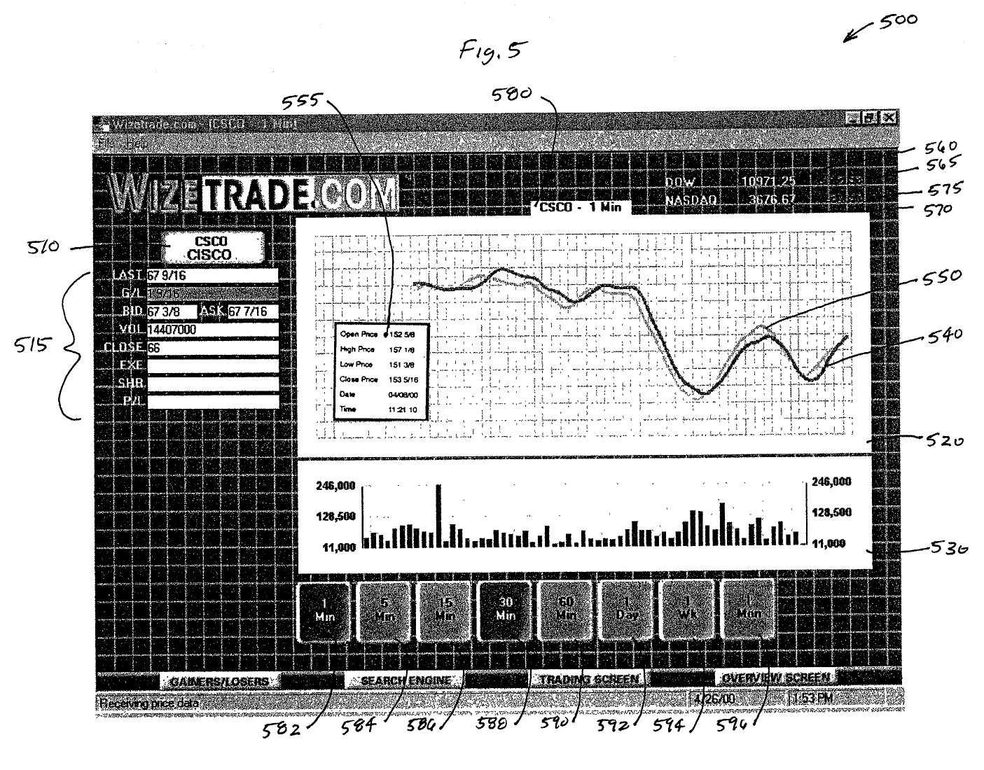

As will be described below in reference to FIG. 5, the present invention uses a regression analysis to calculate an opening value trend and a closing value trend for each of the time intervals for each of the investments 310, 320, 330, 340 and 350. The color of the indicators 310a-h, 320a-h, 330a-h, 340a-h and 350a-h is based on a comparison of the opening value trend to the closing value trend for each time interval for each investment 310, 320, 330, 340 and 350, and whether a long trade 314a, 324a, 334a, 344a and 354a or short trade 314b, 324b, 334b, 344b and 354b has been selected. If a long trade 314a, 324a, 334a, 344a and 354a is selected, the indicators 310a-h, 320a-h, 330a-h, 340a-h and 350a-h will be a first color when the closing value trend is greater than the opening value trend for each time interval for each investment 310, 320, 330, 340 and 350, and a second color when the closing value trend is less than the opening value trend for each time interval for each investment 310, 320, 330, 340 and 350. For example, indicators 310a, 310b, 310c, 310e, 310f, 310g, 310h, 320a, 320b, 320c, 320d, 320f, 320g, 320h, 330a, 330f, 330g, 330h, 340a, 340d, 340h, 350a, 350b and 350g are green in FIG. 3 indicating favorable trading conditions for investments 310, 320, 330, 340 and 350 within the specified time intervals. Indicators 310d, 320e, 330b, 330c, 330d, 330e, 340b, 340c, 340e, 340f, 340g, 350c, 350d, 350e, 350f and 350h are red in FIG. 3 indicating unfavorable trading conditions for investments 310, 320, 330, 340 and 350 within the specified time intervals. If, however, a short trade 314b, 324b, 334b, 344b and 354b is selected, the indicators 310a-h, 320a-h, 330a-h, 340a-h and 350a-h will be the first color when the closing value trend is less than the opening value trend for each time interval for each investment 310, 320, 330, 340 and 350, and the second color when the closing value trend is greater than the opening value trend for each time interval for each investment 310, 320, 330, 340 and 350. Other colors may be used as the first color or the second color.

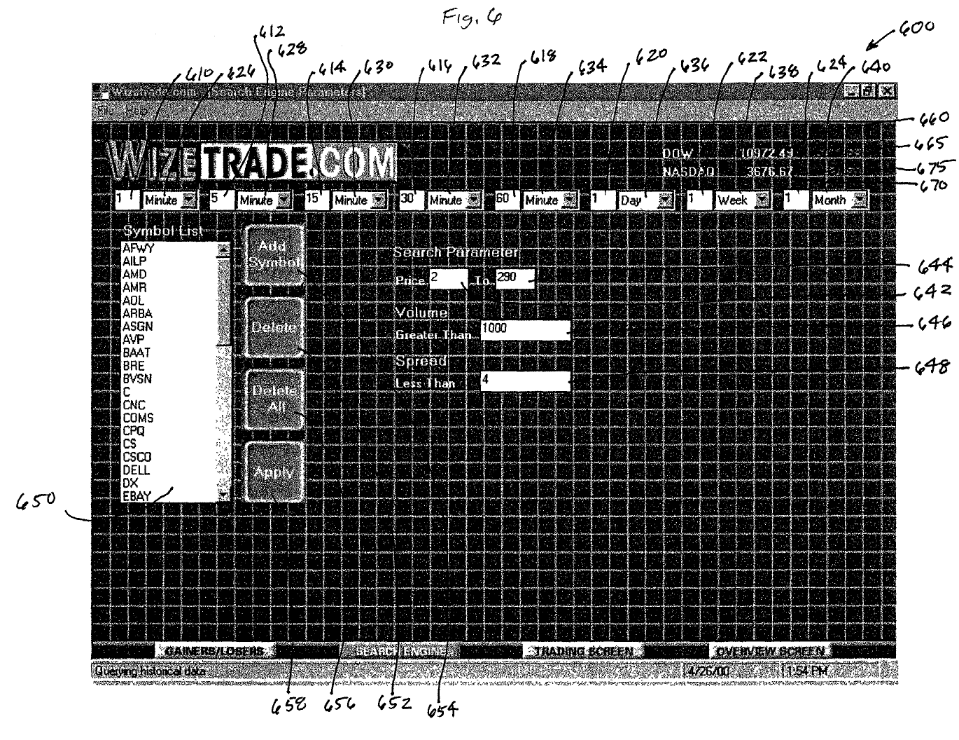

DOW current totals 360 and 365 and NASDAQ current totals 370 and 375 are also displayed. Chart buttons 312a, 322a, 332a, 342a and 352a display charts for an associated single investment. For example, chart button 312a displays charts for investment 310. Change buttons 312b, 322b, 332b, 342b and 352b enable the investor to change the associated investment. For example, change button 312b changes investment 310. Buttons 380, 385, 390 and 395 enable the investor to navigate through the application screens. This strip of buttons is repeated on each screen and has identical functionality on each screen. For example, selecting button 385 from any screen will take the investor to Search Screen 600 (FIG. 6).

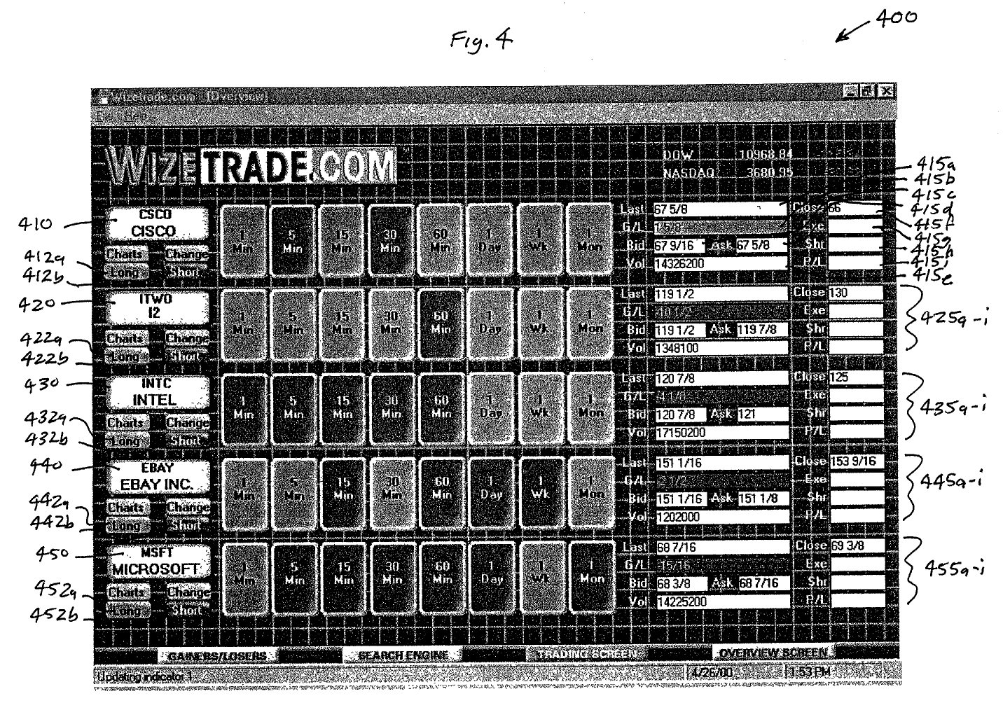

The investor is able to “paper trade” (simulate trading) through Overview Screen 300 by changing to Trading Mode by selecting button 390. FIG. 4, Overview Screen 400 in Trading mode, activates in response to the investor's selection of button 390 (FIG. 3). The elements of Overview Screen 300 (FIG. 3) are decreased in size and pricing and volume information 415a-i, 425a-i, 435a-i, 445a-i and 455a-i for each associated investment 410, 420, 430, 440 and 450 is added. For example, pricing and volume information 415a-i associated with investment 310 is added. Overview Screen 400 in Trading mode displays data such as the last price 415a, 425a, 435a, 445a and 455a, the dollar amount up or down per investment 415b, 425b, 435b, 445b and 455b, the bid price 415c, 425c, 435c, 445c and 455c, the ask price 415d, 425d, 435d, 445d and 455d, the volume 415e, 425e, 435e, 445e and 455e and the closing price 415f, 425f, 435f, 445f and 455f for each investment 410, 420, 430, 440 and 450. The dollar amount up or down per investment 415b, 425b, 435b, 445b and 455b is displayed with color-coding: green may represent a gain, red may represent a loss, while white may represent either no change or no data. Other color combinations can be used.

To simulate trading, the investor enters execute price (Exe) 415g, 425g, 435g, 445g and 455g and the amount of an investment bought or shorted (Shr) 415h, 425h, 435h, 445h and 455h for an associated investment 410, 420, 430, 440 and 450. For example, Exe 415g and Shr 315h are associated with investment 410. The investor chooses from Long or Short on the paper trades for an associated investment 410, 420, 430, 440 and 450 by selecting a Long button 412a, 422a, 432a, 442a and 452a or a Short button 412b, 422b, 432b, 442b and 452b for that investment. For example, Long button 412a and Short button 412b are associated with investment 410. The results of the simulation are shown in P/L 415i, 425i, 435i, 445i and 455i or an associated investment 410, 420, 430, 440 and 450. For example, the results of a trading simulation for investment 410 are displayed in P/L 415i. The results are displayed with color-coding: green may represent a gain, red may represent a loss, while white may represent either no change or no data. Other color combinations can be used. “Paper Trading” information is not carried over from session to session and is lost when the investor terminates the program. By allowing the investor to practice trading in a live market environment without risking capital, the present invention enables equity tracking for year to date, month to date and specified periods of time.

FIG. 5, Chart Screen 500, activates in response to the investor's selection of chart buttons 312a, 322a, 332a, 342a and 352a (FIG. 3). The selection of a specific chart button determines for which investment 310, 320, 330, 340 and 350 (FIG. 3) charts will be displayed. For example, selecting chart button 312a (FIG. 3) results in the display of charted data for investment 310 (FIG. 3). The selected investment appears on Chart Screen 500 as 510. A preferred embodiment of the present invention includes the display of updated pricing and volume information 515 and two charts 520 and 530 for investment 510. DOW current totals 560 and 565 and NASDAQ current totals 570 and 575 are also displayed. Chart 520 is the multiple linear regression chart (MLR). Chart 530 is the Volume chart. MLR Chart 520 displays two regression lines 540 and 550, one color coded to indicate opening prices and the other color coded to indicate closing prices. The present invention preferably uses red to indicate opening prices and green to indicate closing prices. Other colors can be used. For purposes of simplification, the following discussion assumes that regression line 540 is red and regression line 550 is green.

Chart interval 580 represents a period of time, which is established by selecting a time interval button 582, 584, 586, 588, 590, 592, 594 and 596. Any position on the green regression line 550 represents a regression of a prior number of period's closing prices. This regression analysis builds and displays a trend of the closing prices of the investment 510 over a period of time. Any position on the red regression line 540 represents a regression of a prior number of period's opening prices. This regression analysis builds and displays a trend of the opening prices of the investment over a period of time. When the green regression line 550 is above the red regression line 540 on the chart, favorable conditions for a long trade occur. When the red regression line 540 is above the green regression line 550 on the chart, favorable conditions for a short trade occur. A critical point occurs where the red regression line 540 and the green regression line 550 cross. When the red regression line 540 crosses the green regression line 550 and ascends above the green regression line 550, the associated time interval indicator 581-588 will become red. When the green regression line 550 crosses the red regression line 540 and ascends above the red regression line 540, the associated time interval indicator 581-588 will become green. These color changes will also occur on indicators 310a-310h, 320a-320h, 330a-330h, 340a-340h and 350a-350h (FIG. 3) for the associated investment. There is a separate chart associated with each time interval indicator 582, 584, 586, 588, 590, 592, 594 and 596. As the present invention updates the calculations and the indicators change, the investor can be notified via audible or visual alerts. The present invention can also sent electronic notifications to the investor.

Regression algorithms are well known to those of ordinary skill in the art. The MLR algorithms calculate the red regression line 540 and the green regression line 550 on 123499-1000 MLR regression Chart 520. There is a separate regression routine for each time interval indicator 582, 584, 586, 588, 590, 592, 594 and 596. Each routine performs regression analysis on the pricing history for all selected investments 310, 320, 330, 340 and 350 (FIG. 3). There are two regression calculations performed. One is performed on a number of prior consecutive interval closing prices, such as four (4) prior 5-minute interval closing prices. The other regression is performed on a number of prior interval opening prices, such as three (3) prior 5-minute interval opening prices. The current interval's opening price is not included in this calculation. The regression performed on the closing prices is displayed on MLR Chart 520 as the green regression line 550. The regression performed on the opening prices is displayed on MLR Chart 520 as the red regression line 540. The present invention indicates an entry point in the market by the intersection of the green regression line 550 and the red regression line 540.

The investor may obtain more detailed information concerning a specific point along either the green regression line 550 or the red regression line 540 by clicking on the line at the desired point. The present invention will display Infolist 555 containing information about the selected point.

MLR Chart 520 and Volume Chart 530 are only representative of the market trend indicators and analyses available. The selection of multiple linear regression and volume analyses for a preferred embodiment of the present invention does not indicate that the present invention is limited to only those market trend indicators. There are many market trend indicators that the investor can consult to make better trade decisions, such as the following: stochastics, relative strength, directional movement, commodity channel, simple average, exponential average weighted average, MACD (simple), MACD (exponential), momentum/ROC, midrange, William's % R, parabolic stop, volatility stop, trailing stop, high low stop, Bollinger Bands, Keltner Channel, uniform channel, regression channel, swing lines, cycle forecast, on balance volume, overlay chart, point & figure, moving average, moving linear regression, upper envelope, lower envelope, % K, % D, % D slow, % D averaged, % R, RSI, momentum, acceleration, moving average oscillator, moving average momentum, moving average convergence-divergence oscillator, moving average convergence-divergence, MACD signal line, commodity channel index, rate of change in prices, on balance volume variance, standard deviation, volatility ratio, volatility, skew, kurtosis, Williams Accumulated Distribution, Arm's Ease of Movement, plus directional indicator, minus directional indicator, directional movement and average directional movement.

FIG. 6, Search Screen 600, activates in response to the investor's selection of button 385 (FIG. 3). It displays the search parameters of Price Min 642, Price Max 644, Volume 646 and Spread 648. These parameters are important to prevent the system from identifying unqualified trade opportunities. The investor can create a custom list 650 of investments, which is kept from session to session. This is done by adding an investment to custom list 650 via Add 654, deleting an investment from custom list 650 via Delete 652 or deleting all the investments on custom list 650 via Delete All 656. The present invention enables the investor to identify and restrict investment price ranges above Price Min 642 and below Price Max 644 and indicate the Volume 646 minimum within the search engine parameters. The investor can input a maximum Spread 648 and the system will not identify any trade opportunity that exceeds maximum Spread 648. The search is activated by selecting Apply 658. The investor may also set units 626, 628, 630, 632, 634, 636, 638 and 640 and time 610, 612, 614, 616, 618, 620, 622 and 624 interval settings for the button indicators illustrated on the preceding figures. These changes are completed by selecting Apply 658. DOW current totals 660 and 665 and NASDAQ current totals 670 and 675 are also displayed.

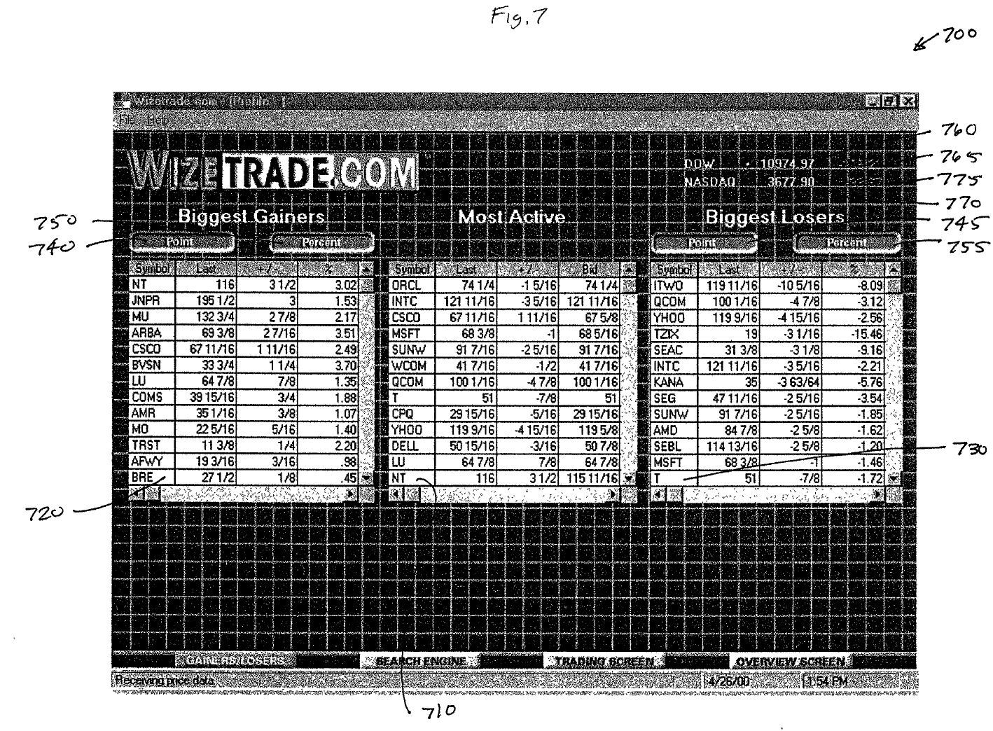

FIG. 7, Gainers/Losers Screen 700, activates in response to the investor's selection of button 380 (FIG. 3). The Gainers/Losers Screen 700 displays the investor's most active trading investments 710, the investor's highest gaining investments 720 and the investor's highest losing investments 730. The investor can sort investments by point 740 and 745 or percentage 750 and 755. DOW current totals 760 and 765 and NASDAQ current totals 770 and 775 are also displayed.

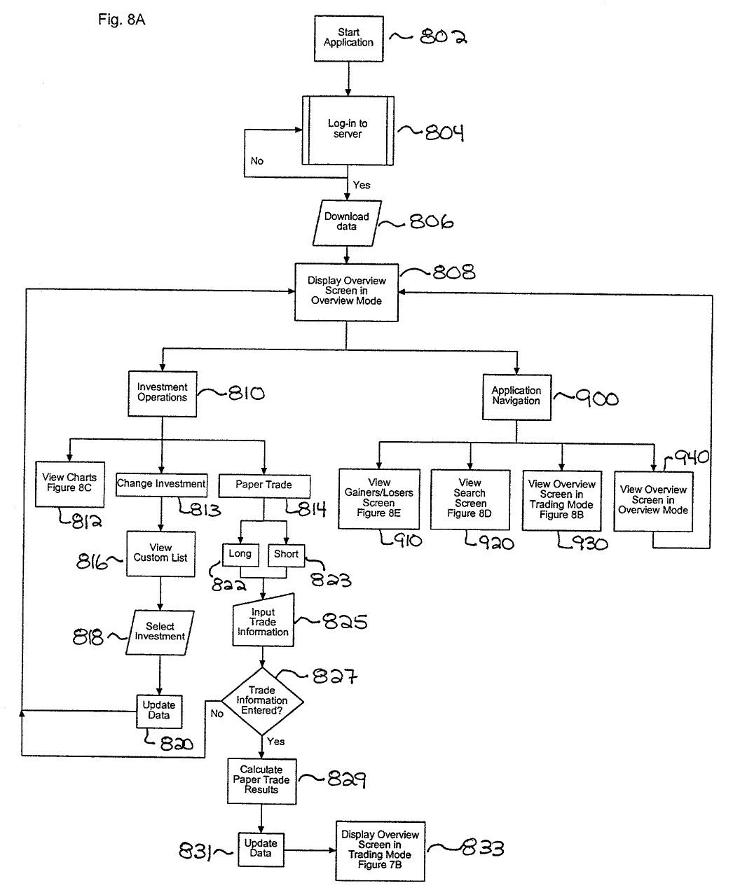

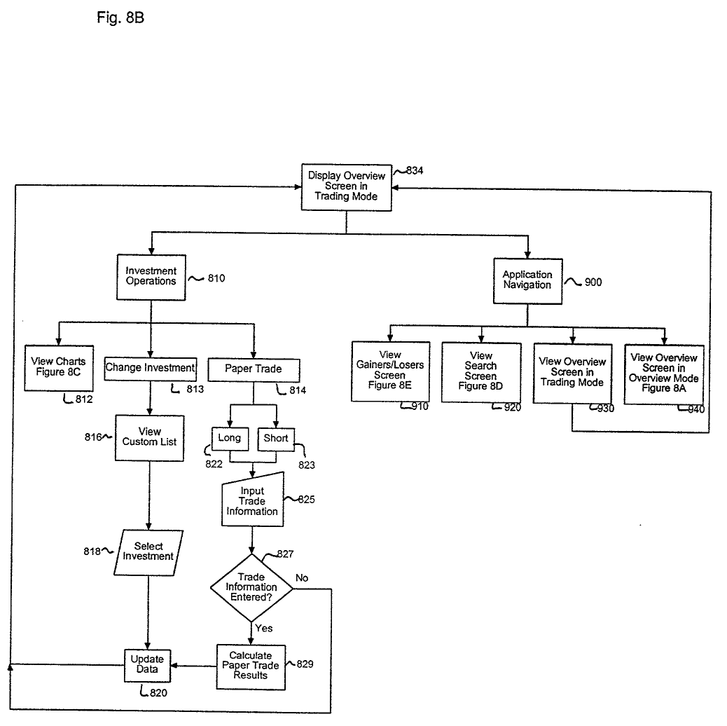

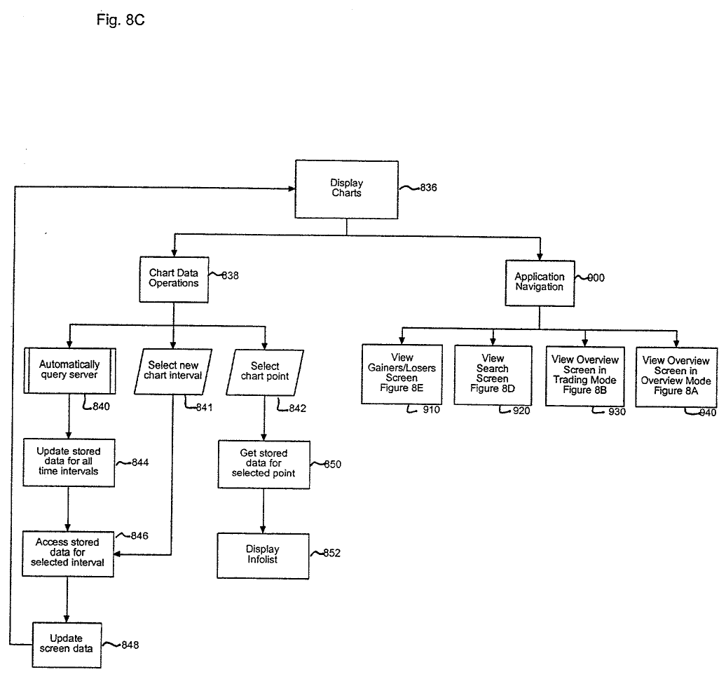

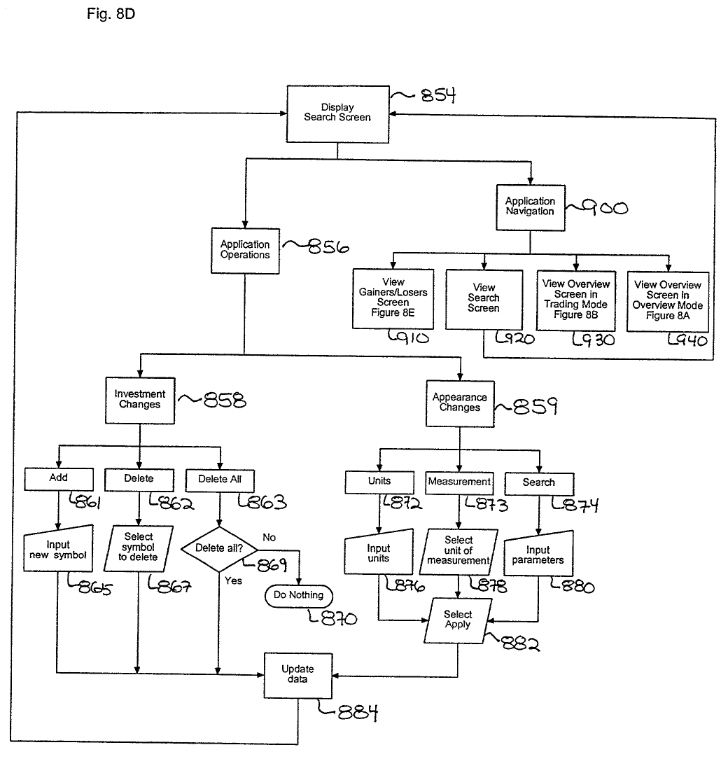

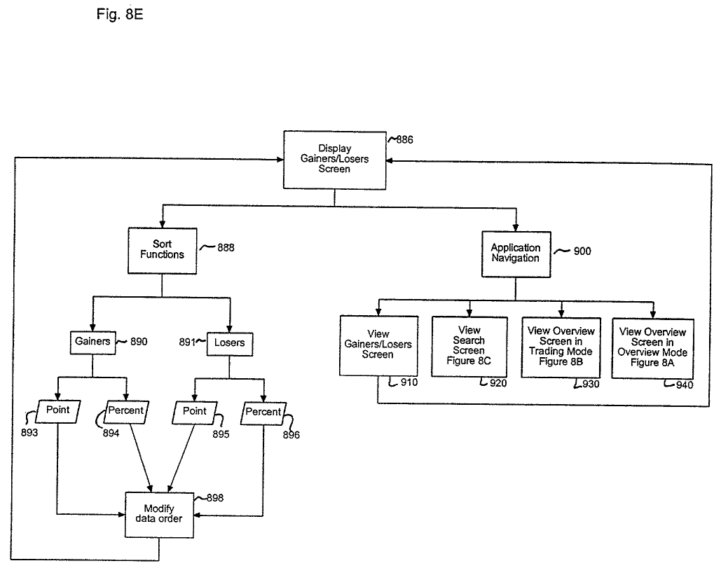

FIGS. 8A-8E display the processing flows for the options of screens FIGS. 3-7. Application Navigation 900 is the same in each of the system screens. Selecting View Gainers/Losers Screen 910 results in the display of FIG. 7, enabling its associated processing of FIG. 8E. Selecting View Search Screen 920 results in the display of FIG. 6, enabling its associated processing of FIG. 8D. Selecting View Overview Screen in Trading Mode 930 results in the display of FIG. 4, enabling its associated processing of FIG. 8B. Selecting View Overview Screen in Overview Mode 940 results in the display of FIG. 3, enabling its associated processing of FIG. 8A.

FIG. 8A focuses on the application start-up and processing flow for FIG. 3. The present invention starts in block 802 where the investor 150-160 (FIG. 1) selects one or more markets 120, 125 or 130 (FIG. 1) to connect to. The specific servers that may be connected to and the details regarding the connection to be established are typically setup during the installation process of the software. The investor 150-160 (FIG. 1) can change, add or delete available connections and/or markets. Next, the present invention prompts the investor to log-on to a server which preferably supplies investment information updates in real-time or near-real-time 804. At this point, the application updates investment information in block 806. After updating, the system displays the Overview Screen in Overview Mode 808.

A preferred embodiment of the present invention enables the investor to perform three main investment operations 810: view charts 812, change investments 813 and paper trade 814. Chart viewing will be more fully explained in FIG. 8C. When the investor selects change investment 813, the system displays a list of currently stored investments 816. The creation of this list will be more fully explained in FIG. 8D. After viewing the possible investment choices 816, the investor then selects an investment 818. The system updates the screen data 820 and then redisplays the Overview Screen in Overview Mode 808 with the newly selected investment and its associated timer interval statuses.

When the investor decides to engage in “paper trading” 814, there are two possible options: Long 822 and Short 823. The process flow for each is identical, except for the data used and the calculations performed. These calculations were previously described in reference to FIG. 5. In order to perform the calculations, the system must have trade information with which to operate. Therefore, the investor has to supply trade information 825. The system then checks for the necessary input 827. If the investor has not input trade information 825 and 827, then all that happens is the system continues to display the current Overview Screen in Overview Mode 808. If the investor has entered trade information 825 and 827, the system calculates the paper trade results 829, update the screen data 831 and then displays the Overview Screen in Trading Mode 833.

The processing of the Overview Screen in Trading Mode 834 shown in FIG. 8B is very similar to that shown in FIG. 8A. The difference is that regardless of whether the investor selects change investment 813 or paper trade 814, the present invention displays the results on the Overview Screen in Trading Mode 834. If changes have been made in the investment selection 813 or if trade information has been entered 825 and 829, the underlying data will be updated 820 and then displayed 834. If data changes have not been made, the system continues to display the Overview Screen in Trading Mode 834.

The processing which occurs when FIG. 5 is displayed is shown in FIG. 8C. When a chart is displayed 836, there are three possible chart data operations 838 that may occur: automatic data updating, changing chart intervals or viewing specific data for a selected data point. The chart is automatically updated from the investment data system 840. Stored data is updated 844 for all the time intervals set in the system for each of the investments selected by the investor in either FIG. 3 or FIG. 4. After the stored data is updated, the system re-accesses the data 846, updates the screen 848 and displays the charts 836. The displayed chart may be for any one of the time intervals set in the system and the investor may navigate between each of the time intervals for the chart by selecting a new chart interval 841. After a new interval has been selected 841, the system accesses the data for the selected interval 846, updates the screen 848 and displays the charts 836. The investor can view more detailed data for a specific chart point by selecting the point 842. The system then gets the stored data for the selected point 850 and displays it on the screen 852. The stored data for the selected point is displayed in the Infolist 555 (FIG. 5).

Not only can the investor search through the available investments to select those that meet a certain criteria, but the investor can also make changes to some of the system parameters through the Search Screen 854 processing of FIG. 8D. There are two main types of changes that result through the use of the Search Screen 600 (FIG. 6). The application operations 856 that can be performed are investment changes 858 and appearance changes 859. The investment symbols appear in the custom list 650 (FIG. 6) can be changed by making investment changes 858. The investor can add 861 new investments, delete 862 an existing investment or delete all 863 of the investments displayed in the custom list 650 (FIG. 6). When the investor adds 861 new investments, the system will prompt the investor to input the new investment symbol 865, then the system will update the data 884 and display the Search Screen 854. If the investor chooses to delete 862 a symbol, the system will prompt the investor to select an investment symbol 867 from custom list 650 (FIG. 6) for deletion. Then, the system will update the data 884 and display the Search Screen 854. Alternatively, if the investor chooses to delete all 863 the investments in custom list 650 (FIG. 6), the system will ask for confirmation 869 that the investor wants to delete the entire list. If the investor affirms the requested deletion of the entire list, then the system updates the data 884 to reflect no entries and displays the Search Screen 854.

The other changes are made to the appearance 859 of the data relative to which investments are displayed for the screens of FIGS. 3-7 and which time intervals the system uses for calculations. When the investor conducts a search 874, the system prompts the investor for the search parameters 880. Once those parameters have been entered, the investor selects Apply 882. The screen data is updated 884 to reflect only those investments that met the search parameters. The Search Screen is displayed 854, showing the matching investments in custom list 650 (FIG. 6). The investor can also change the units 872 for the time intervals used throughout the system. The investor may input the desired units 876 in whole numbers and then select Apply 882. The data will be updated 884 to display the Search Screen 854 with the newly entered units. Measurement 873 changes are similarly made. However, instead of inputting a new unit of measurement, the investor selects a unit of measurement 878 from a list. Then, the investor selects Apply 882, the system updates the data 884 and displays the Search Screen 854 with the newly entered units of measurement.

FIG. 8E displays the processing flow for FIG. 7. When the Gainers/Losers Screen is displayed 886, the investor has the ability to sort 888 the data displayed on that screen. The investor may sort the Gainers 890 by point 893 or percent 894. A point 895 and percent 896 sort is also available for Losers 898.

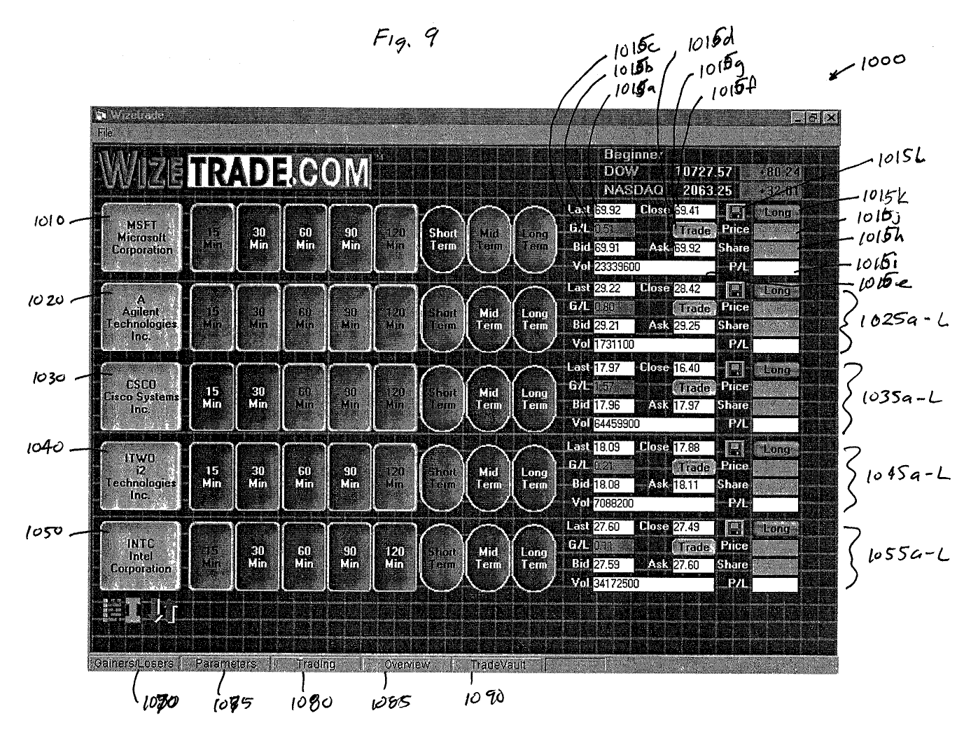

Now referring to FIG. 9, the Trading Screen 1000 in accordance with another embodiment of the present invention is shown. Pricing and volume information 1015a-i, 1025a-i, 1035a-i, 1045a-i and 1055a-i for each associated investment 1010, 1020, 1030, 1040 and 1050 is shown. The pricing and volume information includes data such as the last price 1015a, 1025a, 1035a, 1045a and 1055a, the dollar amount up or down per investment 1015b, 1025b, 1035b, 1045b and 1055b, the bid price 1015c, 1025c, 1035c, 1045c and 1055c, the ask price 1015d, 1025d, 1035d, 1045d and 1055d, the volume 1015e, 1025e, 1035e, 1045e and 1055e, the closing price 1015f, 1025f, 1035f, 1045f and 1055f, a trade button 1015g, 1025g, 1035g, 1045g and 1055g, the number of shares 1015h, 1025h, 1035h, 1045h and 1055h, the profit/loss 1015i, 1025i, 1035i, 1045i and 1055i, the execute price 1015j, 1025j, 1035j, 1045j and 1055j, a long/short trade button 1015k, 1025k, 1035k, 1045k and 1055k, and a save button 10151, 10251, 10351, 10451 and 10551 for each investment 1010, 1020, 1030, 1040 and 1050. The dollar amount up or down per investment 1015b, 1025b, 1035b, 1045b and 1055b is displayed with color-coding: green may represent a gain, red may represent a loss, while white may represent either no change or no data. Other color combinations can be used.

To execute a trade, the investor enters the execute price (Price) 101 5j, 1025j, 1035j, 1045j and 1055j and the amount of an investment bought or shorted (Share) 1015h, 1025h, 1035h, 1045h and 1055h for an associated investment 1010, 1020, 1030, 1040 and 1050. The investor chooses from Long or Short for an associated investment 1010, 1020, 1030, 1040 and 1050 by clicking on the long/short button 1015k, 1025k, 1035k, 1045k and 1055k for that investment. The results of the trade are shown in P/L 1015i, 1025i, 1035i, 1045i and 1055i for an associated investment 1010, 1020, 1030, 1040 and 1050. The results are displayed with color-coding: green may represent a gain, red may represent a loss, while white may represent either no change or no data. Other color combinations can be used. The trade button 1015g, 1025g, 1035g, 1045g and 1055g either execute the trade (real or simulated) or connects the investor to the electronic or online brokerage service. The save button 10151, 10251, 10351, 10451 and 10551 saves the transaction so that the investor can keep track of his or her historical trading activity.

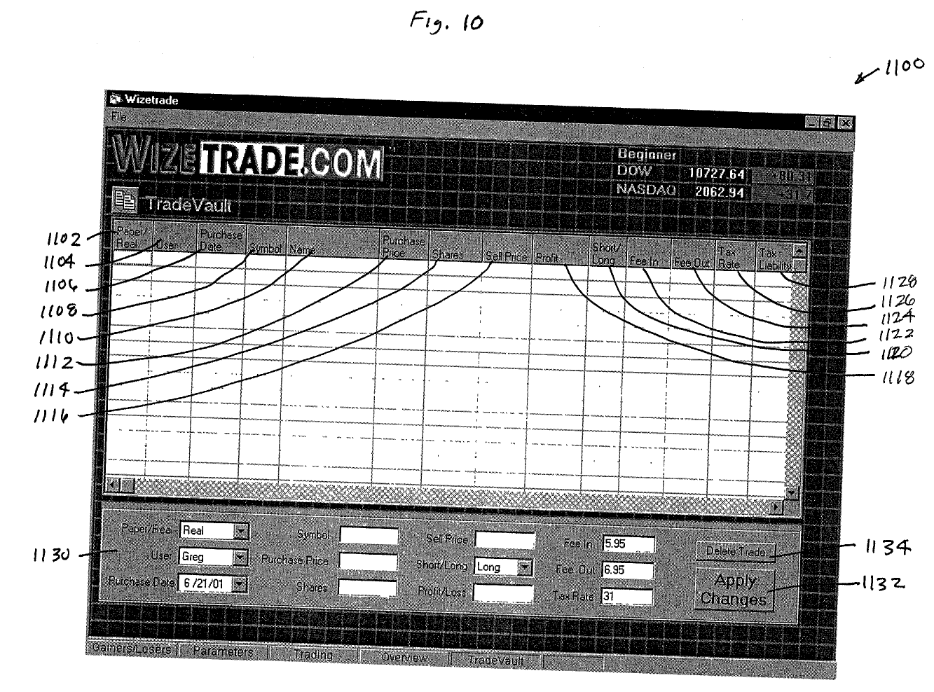

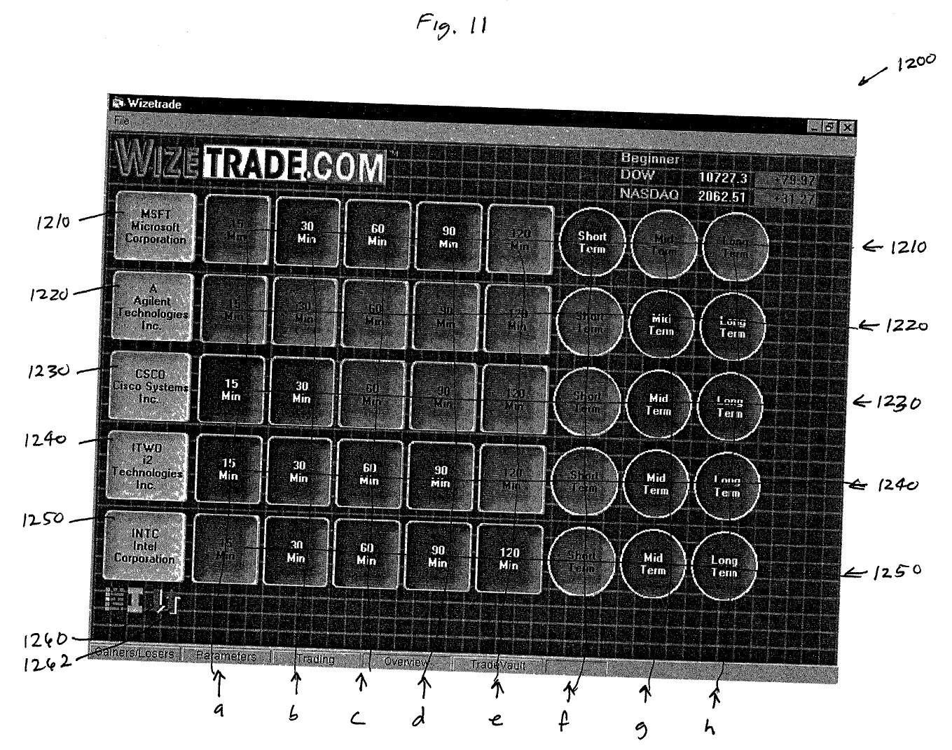

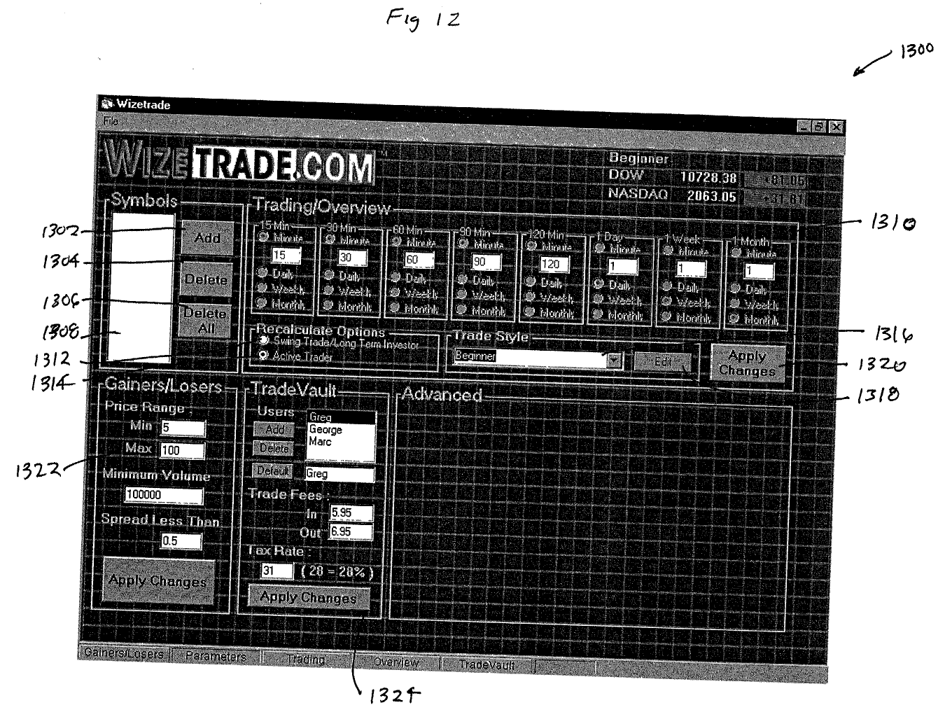

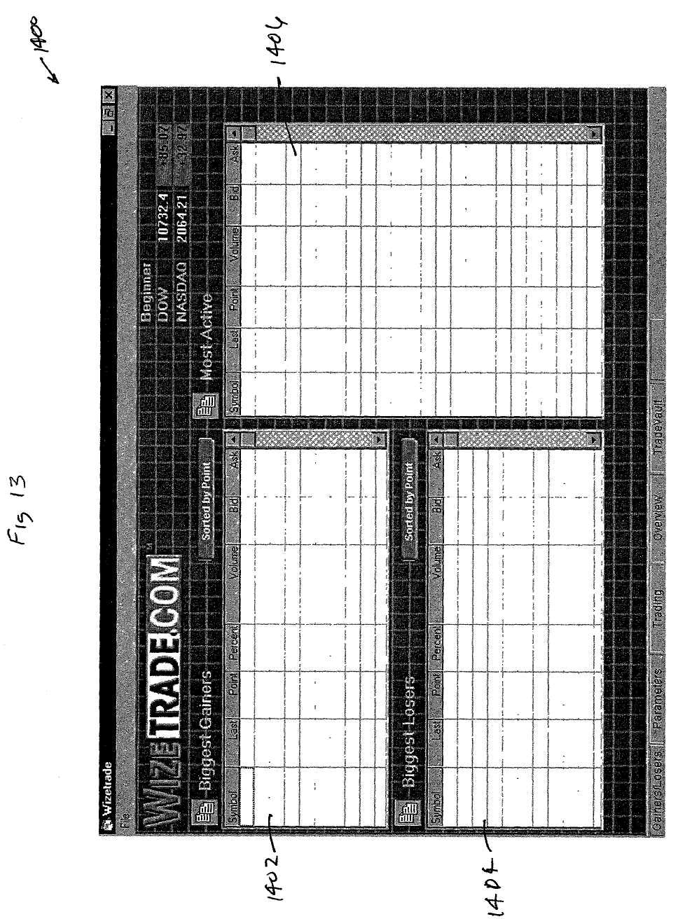

Buttons 1070, 1075, 1080, 1085 and 1090 enable the investor to navigate through the application screens. This strip of buttons is repeated on each screen and has identical functionality on each screen. Button 1070 corresponds to the Gainer/Losers Screen 1400 (FIG. 13). Button 1075 corresponds to the Parameters Screen 1300 (FIG. 12). Button 1080 corresponds to the Traders Screen 1000 (FIG. 9). Button 1085 corresponds to the Overview Screen 1200 (FIG. 11). Button 1090 corresponds to the Trade Vault Screen 1100 (FIG. 10).

FIG. 10 is the Trade Vault Screen 1100 in accordance with another embodiment of the present invention. The Trade Vault shows the paper and real trades that were saved by the investor by using the save button 10151, 10251, 10351, 10451 and 10551 in FIG. 9. The Trade Vault Screen shows whether the trade was simulated (paper) or real 1102, the user 1104, the purchase date 1106, the trading symbol 1108, the investment name 1110, the purchase price 1112, the number of shares 1114, the selling price 1116, the profit 1118, whether the trade was long or short 1120, the fee in 1122, the fee out 1124, the tax rate 1126 and the tax liability 1128. Data can be changed or added using the input section 1130. The changes can be applied using the apply changes button 1132. Trades can be deleted using the delete trade button 1134.

FIG. 11 is the Overview Screen 1200 in accordance with another embodiment of the present invention. The Overview Screen 1200 enables the investor to recognize trends and directional movements. Overview Screen 1200 contains information about several selected investments 1210, 1220, 1230, 1240 and 1250. Color coded indicators 1210a-2110h, 1220a-1220h, 1230a1230h, 1240a1240h and 1250a-1250h are displayed for each of the selected investments 1210, 1220, 1230, 1240 and 1250. These indicators are preferably laid out in a grid fashion, but can be otherwise configured. Each indicator 1210a-1210h, 1220a-1220h, 1230a-1230h, 1240a-1240h and 1250a-1250h represents information for an associated single investment. Each indicator 1210a-1210h, 1220a-1220h, 1230a-1230h, 1240a-1240h and 1250a-1250h displays the chosen time interval for that indicator. Time intervals may be in minutes, hours, days, weeks or months. In the example shown, the time interval for indicators 1210a, 1220a, 1230a, 1240a and 1250a is fifteen minutes; the time interval for indicators 1210b, 1220b, 1230b, 1240b and 1250b is thirty minutes; the time interval for indicators 1210c, 1220c, 1230c, 1240c and 1250c is sixty minutes; the time interval for indicators 1210d, 1220d, 1230d, 1240d and 1250d is ninety minutes; the time interval for indicators 1210e, 1220e, 1230e, 1240e and 1250e is one hundred and twenty minutes; the time interval for indicators 1210f, 1220f, 1230f, 1240f and 1250f is short term (days; the time interval for indicators 1210g, 1220g, 1230g, 1240g and 1250g is mid-term (weeks); and the time interval for indicators 1210h, 1220h, 1230h, 1240h and 1250h is long term (months). The investor can use the page down button 1260 and page up button 1265 to scroll through various investments being tracked.

FIG. 12 is the Parameters Screen 1300 in accordance with another embodiment of the present invention. The investor can use the Parameters Screen 1300 to add 1302, delete 1304, or delete all 1306 investments (symbols) 1308 being tracked, change the time intervals displayed in the Trading Screen 1000 (FIG. 9) and the Overview Screen 1200 (FIG. 11) using the entry fields and toggle fields in the Trading/Overview section 1310. The investor can set the recalculation options to swing trade/long term investor 1312 or active trade mode 1314. The investor can also use various preset or stored sets of time intervals by selecting a trade style 1316, such as beginner, expert, long term investor or day trader. These preset or stored time intervals can be edited using the edit button 1318. Changes are applied using the apply changes button 1320. The settings for the Gainers/Losers Screen 1400 (FIG. 13) and the Trade Vault Screen 1100 (FIG. 10) can be set using sections 1322 and 1324 respectively.

FIG. 13 is the Gainers/Losers Screen 1400 in accordance with another embodiment of the present invention. This screen 1400 shows the biggest gainers in section 1402, the biggest losers in section 1404 and the most active in section 1406.

It will be apparent that other programs are readily devised to create charts of the type described and that some commercially available charting programs can be adapted to display only the charts and not the trade indicators. It is not intended that the invention be limited to the particular format shown in FIGS. 1 through 13. As described above, Applicant's invention comprises the development of indicators and their display in such a manner that traders can anticipate price trends and trades using the cross over method signaling buys and sells opportunities.

What is claimed is:

1. A method of displaying trading trends for an investment comprising the steps of:
receiving an opening value and a closing value for the investment for two or more time intervals;
calculating an opening value trend using a market trend indicator and the opening values for the investment;
calculating a closing value trend using the market trend indicator and the closing values for the investment; and
displaying a visual indicator comparing the opening value trend to the closing value trend for the investment.

2. The method as recited in claim 1 wherein the opening value is an opening price and the closing value is a closing price.

3. The method as recited in claim 1 wherein the opening value is an opening trading volume and the closing value is a closing volume.

4. The method as recited in claim 1 wherein the visual indicator is a first color whenever the closing value trend is greater than the opening value trend.

5. The method as recited in claim 4 wherein the first color is green.

6. The method as recited in claim 1 wherein the visual indicator is second color whenever the closing value trend is lower than the opening value trend.

7. The method as recited in claim 6 wherein the second color is red.

8. The method as recited in claim 1 wherein the visual indicator displays the time interval.

9. The method as recited in claim 1 further comprising the step of displaying the opening value trend as a first line and the closing value trend as a second line in a graph.

10. The method as recited in claim 9 further comprising the step of displaying a list of information about a point selected on either the first line or the second line.

11. The method as recited in claim 1 wherein the market trend indicator comprises one or more regression algorithms selected from: stochastics, relative strength, directional movement, commodity channel, simple average, exponential average weighted average, MACD (simple), MACD (exponential), momentum/ROC, midrange, William's % R, parabolic stop, volatility stop, trailing stop, high low stop, Bollinger Bands, Keltner Channel, uniform channel, regression channel, swing lines, cycle forecast, on balance volume, overlay chart, point & figure, moving average, moving linear regression, upper envelope, lower envelope, % K, % D, % D slow, % D averaged, % R, RSI, momentum, acceleration, moving average oscillator, moving average momentum, moving average convergence-divergence oscillator, moving average convergence-divergence, MACD signal line, commodity channel index, rate of change in prices, on balance volume variance, standard deviation, volatility ratio, volatility, skew, kurtosis, Williams Accumulated Distribution, Arm's Ease of Movement, plus directional indicator, minus directional indicator, directional movement and average directional movement.

12. The method as recited in claim 1 wherein the opening value trend is calculated without using the opening value from the most recent time interval.

13. The method as recited in claim 1 further comprising the steps of:
selecting a market information source;
communicably connecting to the market information source; and
selecting the investment.

14. The method as recited in claim 1 further comprising the step of executing a trade involving the investment.

15. The method as recited in claim 1 further comprising the step of simulating an execution of a trade involving the investment.

16. The method as recited in claim 1 further comprising the step of calculating a potential tax liability for an execution of a trade involving the investment.

17. The method as recited in claim 1 further comprising the step of searching for one or more investment trading opportunities based on one or more search criteria.

18. The method as recited in claim 1 further comprising the step of selecting the time interval.

19. The method as recited in claim 1 wherein the time interval is a preset time based on a user profile.

20. The method as recited in claim 1 further comprising the step of repeating the steps of receiving the opening value and the closing value, calculating the opening value trend and the closing value trend, and displaying the visual indicator for a set of different time intervals.

21. The method as recited in claim 22 wherein the set of different time intervals comprises fifteen minutes, thirty minutes, one hour, ninety minutes and two hours.

22. The method as recited in claim 22 wherein the set of different time intervals comprises one day, one week and one month.

23. The method as recited in claim 1 further comprising the step of repeating the steps of receiving the opening value and the closing value, calculating the opening value trend and the closing value trend, and displaying the visual indicator for two or more investments.

24. The method as recited in claim 1 further comprising the step of updating the opening values, the closing values, the opening value trend, the closing value trend and the visual indicator.

25. The method as recited in claim 24 further comprising the step of signaling a user whenever the visual indicator changes.

26. A computer program embodied in a computer readable medium for displaying trading trends for an investment:
a code segment for receiving an opening value and a closing value for the investment for two or more time intervals;
a code segment for calculating an opening value trend using a market trend indicator and the opening values for the investment;
a code segment for calculating a closing value trend using the market trend indicator and the closing values for the investment; and
a code segment for displaying a visual indicator comparing the opening value trend to the closing value trend for the investment.

27. The computer program as recited in claim 26 further comprising a code segment for displaying the opening value trend as a first line and the closing value trend as a second line in a graph.

28. The computer program as recited in claim 27 further comprising a code segment for displaying a list of information about a point selected on either the first line or the second line.

29. The computer program as recited in claim 26 wherein the market trend indicator comprises one or more regression algorithms selected from: stochastics, relative strength, directional movement, commodity channel, simple average, exponential average weighted average, MACD (simple), MACD (exponential), momentum/ROC, midrange, William's % R, parabolic stop, volatility stop, trailing stop, high low stop, Bollinger Bands, Keltner Channel, uniform channel, regression channel, swing lines, cycle forecast, on balance volume, overlay chart, point & figure, moving average, moving linear regression, upper envelope, lower envelope, % K, % D, % D slow, % D averaged, % R, RSI, momentum, acceleration, moving average oscillator, moving average momentum, moving average convergence-divergence oscillator, moving average convergence-divergence, MACD signal line, commodity channel index, rate of change in prices, on balance volume variance, standard deviation, volatility ratio, volatility, skew, kurtosis, Williams Accumulated Distribution, Arm's Ease of Movement, plus directional indicator, minus directional indicator, directional movement and average directional movement.

30. The computer program as recited in claim 26 further comprising:
a code segment for selecting a market information source;
a code segment for communicably connecting to the market information source; and
a code segment for selecting the investment.

31. The computer program as recited in claim 26 further comprising a code segment for executing a trade involving the investment.

32. The computer program as recited in claim 26 further comprising a code segment for simulating an execution of a trade involving the investment.

33. The computer program as recited in claim 26 further comprising a code segment for calculating a potential tax liability for an execution of a trade involving the investment.

34. The computer program as recited in claim 26 further comprising a code segment for searching for one or more investment trading opportunities based on one or more search criteria.

35. The computer program as recited in claim 26 further comprising a code segment for selecting the time interval.

36. The computer program as recited in claim 26 further comprising a code segment for repeating the steps of receiving the opening value and the closing value, calculating the opening value trend and the closing value trend, and displaying the visual indicator for a set of different time intervals.

37. The computer program as recited in claim 26 further comprising a code segment for repeating the steps of receiving the opening value and the closing value, calculating the opening value trend and the closing value trend, and displaying the visual indicator for two or more investments.

38. The computer program as recited in claim 26 further comprising a code segment for updating the opening values, the closing values, the opening value trend, the closing value trend and the visual indicator.

39. The computer program as recited in claim 38 further comprising a code segment for signaling a user whenever the visual indicator changes.

40. An apparatus for displaying trading trends for an investment comprising:
a computer communicably connected to a market information source;
a display communicably connected to the computer; and
the computer receiving an opening value and a closing value for the investment for two or more time intervals from the market information source, calculating an opening value trend using a market trend indicator and the opening values for the investment, calculating a closing value trend using the market trend indicator and the closing values for the investment, and displaying a visual indicator comparing the opening value trend to the closing value trend for the investment on the display.
